(19) United States
(12) Patent Application Publication
(10) Pub. No.: US 2017/0026307 A1
(43) Pub. Date: Jan. 26, 2017

(54) System And Method For Remote Managing Applications In A Network Appliance

(71) Applicant: NETGEAR, Inc., San Jose, CA (US)

(72) Inventors: Bing H. Cheng, Taichung (TW); Sandeep Harpalani, Fremont, CA (US)

(73) Assignee: NETGEAR, Inc.

(21) Appl. No.: 15/213,789

(22) Filed: Jul. 19, 2016

Related U.S. Application Data
(60) Provisional application No. 62/194,415, filed on Jul. 20, 2015.

(51) Int. Cl. H04L 12/911; H04L 29/08; H04L 12/24

(52) U.S. Cl. CPC H04L 47/70; H04L 41/0681; H04L 67/10; H04L 67/16

(57) ABSTRACT

A computer-implemented method for providing an interface to a first network device using a second device through one or more wired and/or wireless networks is described. The method includes receiving an installation indication at a processor of the first network device from a remote application on a second network device, determining whether a correlated application corresponding to the remote application is installed on the first network device, transceiving data between the correlated application to the second network device based on a determination that the correlated application corresponding to the remote application is installed on the first network device, and downloading the correlated application corresponding to the remote application based on a determination that the correlated application corresponding to the remote application is not installed on the first network device.

### CROSS-REFERENCE TO RELATED APPLICATIONS

This application claims the benefit of U.S. Provisional Patent Application No. 62/194,415, filed Jul. 20, 2015, hereby incorporated by reference in its entirety.

### FIELD OF INVENTION

This invention generally relates to the field of providing a remote interface to a second device on a network that allows a user of the remote interface to manage and interact with applications on the device. More specifically, the present application is directed to an interface implemented on a network connected computing device to allow a user to install, identify, interact and otherwise manage applications installed on another network device.

### BACKGROUND OF THE INVENTION

Network appliances include a plurality of different types of devices that implement a wired and/or wireless communication protocol to allow intercommunication between a plurality of computing devices. The most well-known device of this type is a wired or wireless router. Routers and other network devices of this type typically had only minimal memory and processing power to manage the receiving and forwarding of data packets implementing the data network. Further, because of the limited capability and functionality required of them, these devices typically do not include direct input or output capabilities for human access. They thus often are referred to as “headless devices.”

Improvements in both the cost Of providing and the capabilities of memory and processing power have made it more reasonable to increase the available memory and processing power and, accordingly, the functionality being perfumed by the network device. An example of an application that may be executed using the additional capabilities is a photo aggregation application that identifies and serves photos from any device such as smart phones, personal computers or network appliances with storage, applications executed by devices that transmit photos from the application to the counterpart application that interfaces the end users and lets the users browse the photos. The photos may, for example, be stored by the application in a USB storage device attached to a router, on a network attached storage (NAS) device, on a computer using the communication network, etc.

However, despite the increases in computing power, network devices typically are still “headless” in that they still do not include direct input or output capabilities for human access. These devices typically are physically located positioned behind computing systems, within closets, in basements, etc, such that accessing the devices on any regular basis would be inconvenient even if they were to include direct input or output capabilities for human access. Accordingly, a photo aggregator application implemented on the network device would not be able to provide functionality allowing users to browse, send, or otherwise manipulate the photos aggregated by the network device. Further, the memory and processing power of the network device are still necessarily limited based on size, cost, and other constraints of providing these capabilities in a network device.

According to another example, a network device may be an “Internet of Things” (IOT) device that includes embedded electronics configured for network connectivity and further configured to collect and exchange data. Such devices include sensors that allow objects to be sensed and actuators allowing the objects to be controlled remotely across existing network infrastructure(s).

What is needed is a system and/or method for managing applications on a network device using a personal computing device in communication with the network device. What is further needed is a system and/or method in which managing an application includes identifying and managing the installation of the application for the network device, displaying output generated by the application, and receiving input to be transmitted to the application.

### SUMMARY

According to one embodiment of the invention, a computer-implemented method for providing an interface to a first network device using a second device through one or more wired and/or wireless networks is described. The method includes receiving an installation indication at a processor of the first network device from a remote application on a second network device, determining whether a correlated application corresponding to the remote application is installed on the first network device, transceiving data between the correlated application to the second network device based on a determination that the correlated application corresponding to the remote application is installed on the first network device, and downloading the correlated application corresponding to the remote application based on a determination that the correlated application corresponding to the remote application is not installed on the first network device.

In another embodiment, downloading a correlated application includes transmitting an installation message to the portable computing device including a network device identifier. Receiving an installation indication from the remote application may include receiving a message having a predefined protocol including the installation indication. Further, the correlated application may be selected from a plurality of correlated applications corresponding to the remote application based on one or more characteristics of the first network device. The correlated application may further be configured for receiving a discovery query from a remote application on the portable computing device looking for devices supporting the counterpart function/application and responding to the queries with a positive feedback if the router can support the counterpart function.

In another embodiment, the correlated application may execute the correlated application including instructions to modify the communication with the plurality of client devices. Modifying the communication can include configuring the first network device to act as an Internet of Things (IOT) hub for any IOT devices connecting to the network device. Modifying the communication can also include exchanging information between the correlated application being executed and the portable computing device. Modifying the communication can also include updating firmware including instructions for performing the communication with the plurality of devices.

According to another embodiment of the invention, a first network device generating a wired and/or wireless network and configured to facilitate communication with a plurality of client devices to the first network device is described. The first network device includes a non-transient network device memory configured to store one or more network device applications and a network device processor configured to execute instructions to implement the one or more network device applications, the network device applications including at least a network device application manager. The network device application manager is configured to establish a communication link with a client device, receive an installation indication from a remote application on the client device asking the network device to install a network device application that is a counterpart to the remote application, download the counterpart application corresponding to the remote application based on the received installation instruction, install the counterpart application on the first network device, and perform functions based on the inputs from the remote application and return the results to the remote application to display to a user of the client device.

According to yet another embodiment of the invention, a portable computing device (PCD) for use in communicating with a network device generating a wired and/or wireless network to facilitate communication with a plurality of client devices. The portable computing device includes a non-transient network device memory configured to store one or more device applications and a processor configured to execute instructions to implement the one or more device applications. Implementing the device applications includes identifying the network device, determining whether a network device application corresponding to the device application is installed on the network device, transceiving data with the network device application based on the execution of the network device application, and displaying received output from the received network device application.

Other features and advantages of the invention will become apparent to those skilled in the art upon review of the following detailed description, claims and drawings in which like numerals are used to designate like features.

### BRIEF DESCRIPTION OF THE DRAWINGS

Preferred exemplary embodiments of the invention are illustrated in the accompanying drawings in which like reference numerals represent like parts throughout, and in which:

FIG. 1 schematically illustrates a networking environment for a network device having application managed using a portable computing device and providing intercommunication between one or more devices on an internal network and communication between the devices on the internal network and an external network, according to an exemplary embodiment;

FIG. 2 is a flowchart illustrating a method for managing router applications on a network device using an application interface on a portable computing device communicating on a network generated by the network device, according to an exemplary embodiment; and

FIG. 3 is a flowchart illustrating a method for identifying router applications for a network device specific to the network device using an application interface on a portable computing device, according to an exemplary embodiment.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION

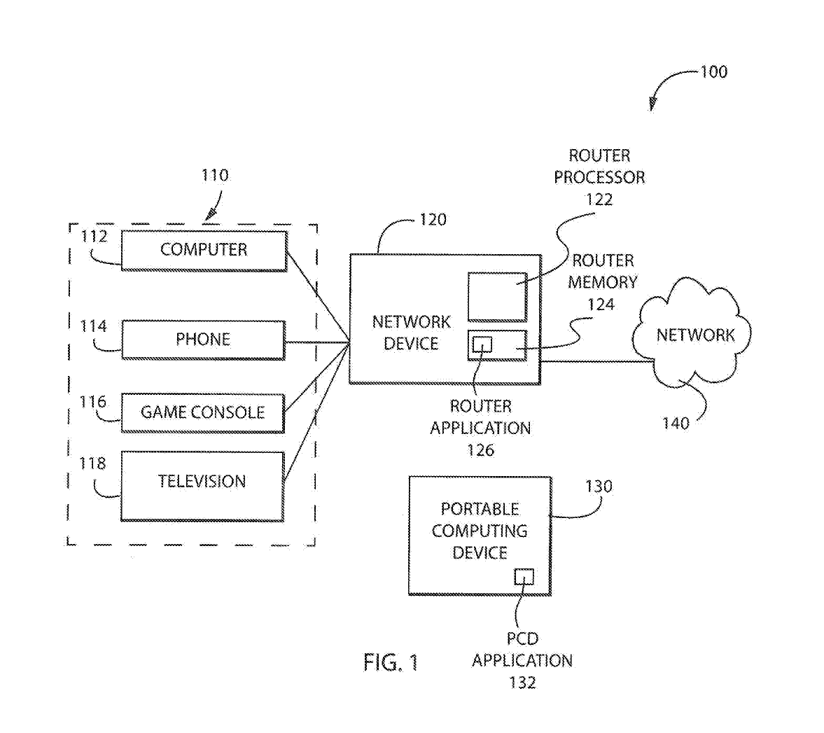

Referring now to FIG. 1, a networking environment 100 for a first network device 120 having applications managed using a second network device, such as a portable computing device 130 (PCD). According to an exemplary embodiment, the first network device 120 may be a network router providing intercommunication between one or more devices on an internal network 110 and communication between the devices on the internal network 110 and an external network 140 is shown, according to an exemplary embodiment. For ease of description and although first network device 120 is not limited to a network router, first network device 120 is described herein as being a network router. The information being transmitted to and from external network 140 and internal network 110 is transmitted using a plurality of data packets, collectively referred to herein as a data stream. The data stream from external network 140 to internal network 110 is referred to as a “downlink data stream,” while the data stream from internal network 110 to external network 140 is referred to as an “uplink data stream.”

Internal network 110 may be a local area network configured to provide communication of information with a plurality of devices and applications in relatively close proximity to each other, such as within a home, school, office building, etc. Internal network 110 includes applications running on a personal computing device 112 such as a desktop computer, a laptop computer, a tablet, etc, a smart phone 114, a game device 116, a streaming media player 118, and an Internet of Things (IOT) device 119. Any or all of these or other devices could be present in a given internal network. It should be understood that although FIG. 1 show specific devices, these are merely provided as examples. Internal network 110 may optionally include a single device in communication with network device 120. Internal network 110 may further include one or more additional network communication devices to provide intercommunication between devices on the network and communication with network device 120.

Applications on devices 112-119 may have applications executed thereon that utilize and exchange data on the internal network 110 and/or the external network 140. Exemplary applications may include social media applications, file sharing applications, game applications having a social and/or competitive aspect with players on other devices, sensor based applications, etc. According to an exemplary embodiment, communication by the applications on the internal network 110 is provided through the network device 120. The link between devices 112-119 and network device 120 may be a wired network, such as Ethernet, or a wireless network, such as Wi-Fi. Devices 112-119 may also be configured for intercommunication, for example using the Bluetooth or Zigbee communication protocol and/or through network device 120 using an internal network address. For example, most IOT (internet of things) devices 119 need a huh as a middle device to communicate with a server. There could be a huh application running on the network device 120 as described below and that application can communicate with these IOT devices and/or other network devices.

Network device 120 may be any device configured to manage the flow of data between internal network 110 and external network 140. Network device may, for example, comprise one or a combination of more than one of a router, a switch, or a gateway. In another embodiment, the network device may be a network attached storage (NAS), a repeater and/or any other device having a processor and memory configured to implement network functionality and the method described herein. Network devices may implement their functionality through one or more network components, such as a network bridge, a switch, a hub, etc. Network devices may further include device connected to the network 110, such as device 112-119.

Functionality described herein as being associated with network device 120 may alternatively be implemented using one or more devices. For example, network device 120 may be configured to include a router in communication with a network switch, either of which can be configured to perform some or all of the functions described herein. Network device 120 may further be implemented using a plurality of network devices in communication with each other, such as a plurality of wireless access points in communication with a gateway router.

Network device 120 is configured to transmit data packets between the two computer networks and/or between devices on the two computer networks. Data packets can include any type of such bundled data transmitted between devices. Where network device 120 is a router, when a data packet is received from either internal network 110 or external network 140, the network device (router) 120 reads address information in the packet to determine their ultimate destination. In a packet-switched network, a “router” is a device which receives packets on one or more input interfaces and which outputs those packets on one of a plurality of output interfaces so as to move those packets within the network from a source device to a destination device. Each packet includes header information, which indicates the destination device in either internal network 110 or external network 140 and a packet body including the data being transmitted.

Network device 120 may be a gateway device that is the exclusive communication channel between internal network 110 and external network 140. Accordingly, all data packets provided to or from the internal network 110 can be viewed using the network device 120. Although network device 120 is shown in FIG. 1 as including specific components in an exemplary configuration, it is important to recognize that network device 120 may include more, fewer, and/or a different configuration of components to implement the functions described herein. The functional components (not shown) of network device 120 may be implemented using hardware including a processing unit, a system memory, and a system bus that couples various system components, including the system memory, to the processing unit. The system bus may be any of several types of bus structures including a memory bus or memory controller, a peripheral bus, and a local bus using any of a variety of bus architectures. Further, the described components may be implemented using hardware and/or software.

Network device 120 is configured to include a router processor 122 and a router memory 124. Router processor 122 may be any type of computer processor configured to receive and execute instructions for applications stored in memory 124. Typically, such applications are used to control the operation of the network device 120, such as a router application management interface 126 and/or one or more router applications 128. The processor may include a single processor or multiple processors performing a distributed computing function.

The memory 124 includes computer storage media in the form of volatile and/or nonvolatile memory such as read only memory (ROM) and random access memory (RAM). A basic input/output system (BIOS), containing the basic routines that help to transfer information between elements within network device 120, such as during start-up or networking operations, is typically stored in ROM. Although typically stored in ROM, memory may include offsite memory resident application, such as cloud computing based applications. RAM typically contains data and/or program modules that are immediately accessible to and/or presently being operated on by the processing unit. The network device 120 may also include other removable/non-removable, volatile/nonvolatile computer storage media, such as flash memory.

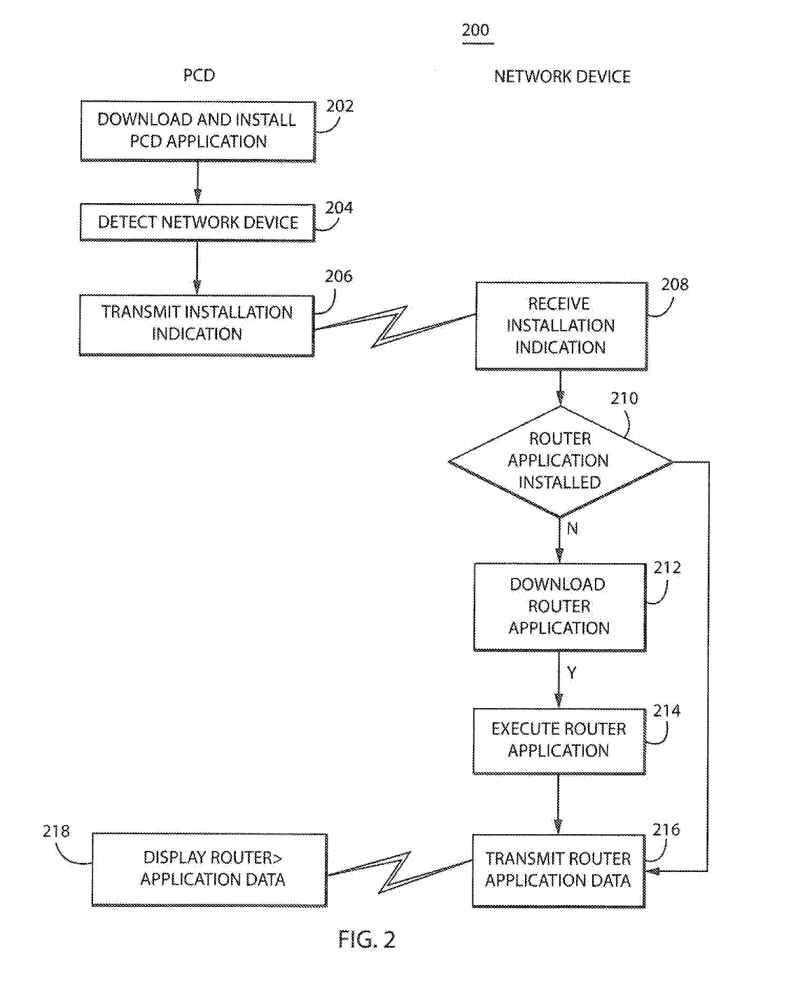

Although network device 120 may be any of a variety of devices, for clarity network device 120 is further described herein with reference to a router-type network device as shown in FIG. 2. Although not shown, router 120 includes a packet router input, a packet analyzer, and a packet router output. Although network device 120 is shown in FIG. 2 as including a number of functional embodiments represented as separate components, it should be understood that the same functional component may be used to implement one or more of the functional embodiments.

Packet router input is an input port receiving data packets from devices on either of internal network 110 and external network 140. The router input may be one or more Ethernet port, a wireless transceiver, or another device receiving data packets and forwarding the packets to device 120. Similarly, packet router output is an output port transmitting data packets to devices on either of internal network 110 and external network 140. The router output. may also be an Ethernet port, a wireless transceiver, or another device for transmitting data packets. A packet analyzer for network device 120 may be used to perform operations on packets, such as rewriting the packets' headers according to their routing protocol, implementing virus checking and/or verification processes on the data packets, and/or re-encapsulating the packets from a first routing protocol to a second routing protocol. The packet analyzer may further be configured to monitor the data in the body of the packet being transported, such as to detect a file type associated with the data in each data packet.

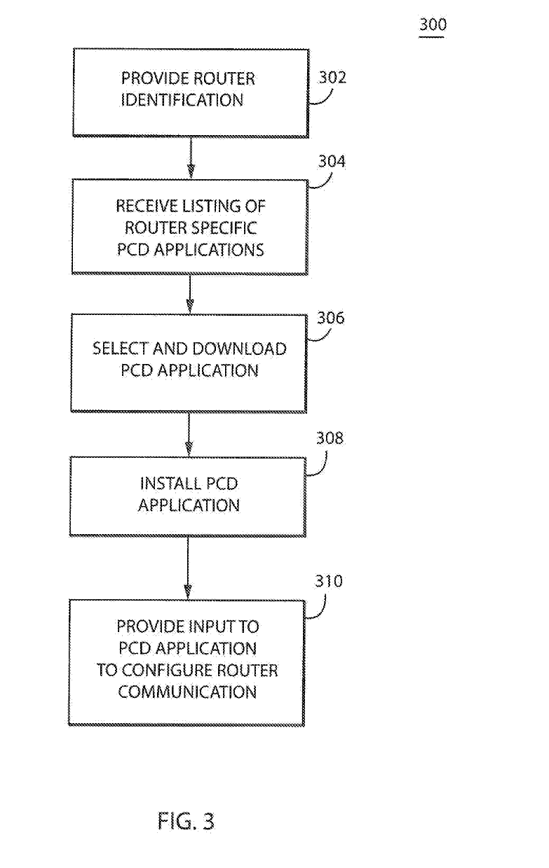

Router application management interface 126 may be software or firmware that is configured to operate in communication with a corresponding personal computing device (PCD) application 132 to manage communication between the network device 120 and the portable computing device pertaining to the installation and/or capabilities of the one or more router applications 128 as described in detail below with reference to FIGS. 2 and 3. Managing applications may include, but is not limited to, identifying applications installed on the network device 120, identifying properties of network device 120 constraining applications 128 that can be executed using the network device 128, and implementing, in conjunction with the PCD application interface 132, input and output functionality associated with one or more of the applications 128.

PCD application 132 is not required to work directly with router applications 128 for input and output. For example, the PCD application 132 may work with a server on the Internet directly for input and output, and that server works with router applications 128 on one or more routers to get and/or set data. The routers may be components of one or more external networks 140 or internal network 110.

The router applications 128 may include steps to be taken by the router processor 122 that affect the operation of network. device 120 in receiving, analyzing, and/or forwarding data packets from one or more of a device on internal network 110 and/or external network 140. Analyzing data packets may include generating router application output based on the analysis. For example, wherein the application 128 is a photo sharing application as described in the background of this application, application 128 may be configured to recognize photo files being transmitted in data packets in a data stream through network device 120 and provide a copy of the photo as an output for storage on, for example, an NAS device (not shown), on a personal computing device on network 110, for display to a user of a PCD router application interface 132 as described hereinbelow, on a hard disk drive HDD which is attached to the router 120 through a USD interface, etc.

Portable computing device 130 may be a computing device on internal network 110 or communicate through external network 140 that includes a portable computing device (PCD) application 132 configured to implement some functionality utilizing a corresponding router application 128 as described below in further detail with reference to FIG. 2. Portable computing device 130 may further include a (PCD) application interface 134 configured to implement an interface allowing the application interface 132 to manage one or more router applications 128 stored in router memory 124 and executed by the router processor 122. Managing the router applications 128 using the portable computing device 130 is described in further detail below with reference to FIG. 3.

External network 140 may be a wide area telecommunication network covering a broad area, such as the Internet. External network 140 may be connected to network device 120 using a wired or wireless connection. For example, a router network device 120 may be connected to a high-bandwidth connection such as a cable modern, a Digital Subscriber Line (DSL) modem, or an integrated Services Digital Network (ISDN) connection to send and receive data with systems through external network 140.

In operation, computing device 130 is configured to include a PCD application 132 corresponding to router applications 128. The PCD application 132, based on a communication protocol conducted by both of the network device 120 and the portable computing device 130, is an application configured to allow a user of the PCD application 132 to perform application functionality utilizing the corresponding router application 128 on the network device 120, as described in detail below with reference to FIG. 2. The PCD application 132 is not required to communicate with router application 128 directly, that communication may be indirect and go through a server an the Internet.

Referring now also to FIG. 2, a flowchart 200 illustrating a method for utilizing router applications on a network device 120 using an application on a portable computing device 130 communicating on a network generated by the network device 120 is shown, according to an exemplary embodiment. Although flowchart 200 includes a multiple steps, performed in a defined order, the functions described herein can be performed using more, less and/or a different ordering of steps.

In a first step 202, a user of the portable computing device 130 downloads and installs a PCD application 132 configured to provide an interface with one or more of the router application management interface 126 and one or more router applications 128. According to an exemplary embodiment, portable computing device 130 may be a smart phone and the user of the smart phone/pad downloads the PCD application 132 using an app store associated with the device, such as Google Play and/or the Apple App Store. Identifying and installing the PCD application 132 may be performed using the PCD application interface 134. PCD application interface 134 may be an application, executable on the PCD 130, receiving, identifying and/or displaying a listing of PCD application 132 and corresponding router applications 128 for an identified network device 120. For example, interface 134 may interact with the Apple® App store, Google Play®, and/or any other application server to obtain the listing and selected applications. According to one exemplary embodiment, installation and/or execution of a PCD application may initiate installation of the corresponding router application 128. Alternatively, installation of a router application 128 may be triggered by interaction between and network device and a sensor in another network device. Advantageously, using the described system and method, a network device vendor is not required to implement their own application store for the applications executed on their network devices. Instead, the described system and method allows the vendor to manage applications running on the network devices through the app store for the PCDs (e.g. Apple store, Google Play), where the corresponding apps are offered.

Referring now also to FIG. 1, flowchart 300 illustrating a method for identifying router applications for a network device 120 specific to the network device 120 using the PCD application interface 134 on the portable computing device 130 is shown, according to an exemplary embodiment. Although flowchart 100 includes a multiple steps, performed in a defined order, the functions described herein can be performed using more, less and/or a different ordering of steps.

In a first step 302, application interface 134 may query network device 120 to determine network device properties relevant to the identification of router applications for the network device 120. Exemplary properties may include identification of a producer and model of the network device 120, identification of the processing power, type, operating system, etc. of the router processor 122, identification of the available storage space for router memory 124, and/or any other property that affects the identification of router applications that are suitable for the network device 120. According to an exemplary embodiment, application interface 134 may be configured to perform the query in step 302 based on a determination that the portable computing device 130 has established a communication channel with the network device 120, based on execution of the application interface 134 on computing device 130, based on a command received from a user of the application interface 134, etc.

Following the determination of the network device properties, the process proceeds to step 304 where the application interface 134 is configured to provide a listing of PCD applications 132 specific to the network device 120 based on the properties received in step 302. The listing of PCD applications 132 may further be specific to the network device 120 such that the applications 128 have components configured for cooperative execution on both of network device 120 and computing device 130. The listing of PCD applications 132 may include information regarding the application such as application functionality, application properties (size, cost, etc.).

In a step 306, the portable computing device 130 is configured to receive a selection from a user of a specific PCD application 132 from the listing of applications and that PCD application 132, but not the corresponding router application 128, is downloaded to the portable computing device 130 from the app store associated with the PCD. According to an alternative embodiment, the selected PCD application 132 is downloaded to the computing device 130 and the corresponding router application 128 is downloaded to the network device 120 per communication between the PCD application interface 134 and the RAMI 126. Following the download, the PCD application 132 is installed on the computing device 130 in a step 308.

In a step 310, the router application 128 may be executed using a processor of the network device 120 and the PCD application 132 may be specifically configured for communication with the network device 120. Configuring the PCD application 132 may include identification of a specific network device 120, such as using a MAC address, identification of a network implemented by the network device 120, using a device name previously associated with the network device 120, etc. Alternatively, dependent on the nature of the PCD application 132 and corresponding application 128, configuring the PCD application 132 may include identification of a type of network device 120, such that the PCD application 132 is configured to recognize and perform some functionality whenever the portable computing device 130 is in communication with a network implement by that type of network device 120.

Referring now back to FIG. 2, following the installation and configuration of the PCD application 132, the PCD application 132 is configured to detect the network device 120 in a step 204. Detection of the device may be performed by transmitting a query over a network to the network device 120, detecting the availability of a network implemented by the network device 120, and/or any other method of detection. Detecting the network device 120 may further include establishing a communication channel between the network device 120 and the portable computing device 130.

Upon detecting the network device 120 in step 206, PCD application 132 on device 130 is configured to transmit an installation indication to the network device 120 in a step 206, the installation indication being received at the network device in a step 208. The installation indication may a communication indicating that the PCD application 132 has been installed on the portable computing device 130.

Upon receipt of the installation indication, the network device 120 may make a determination in a step 210 whether the application 128 corresponding to the PCD application 132 is installed on the network device 120. If the application 128 is installed, the application 128 transmits, in a step 216, application output information to the portable computing device 130. The application output information is received at the PCD application 132 and displayed to the user in a step 218.

If it is determined in step 210 that the application 128 corresponding to the PCD application 132 is not installed on the network device 120, the network device 120 may download the router application 128 in a step 212. The router application 128 may be downloaded directly from the portable computing device 130 where the download of step 306, described above with reference to FIG. 3, included both the PCD application 132 component and the router application 128 component. Alternatively, the router application 128 may be downloaded directly from a server or application store. The source of the download may be communicated to the network device 120 by the PCD router application interface over the established communication channel. The downloaded router application 128 may then be installed in a step 214 and executed with output being displayed on the portable computing device 130 in step 216 and 218 and previously described above.

According to an alternative embodiment, in step 212, the downloading of the router application 128 may be customized to the network device 120 based on detected and/or stored attributes of the network device. For example, in some instances, network device 120 may have limited memory. In such instance, a version of the router application 128 having less stringent memory requirements and/or utilizing network memory resources may be downloaded in step 212 and installed in step 214.

According to another alternative embodiment, the downloading of the router application 128 to the network device 120 may be triggered based on detection of an Internet of Things (IOT) device by a client device, such as a portable phone. Thereafter, the client device may provide notification to the network device 120 to prompt installation of the correlated application on the network device 120. In this case, the correlated application may allow the

Certain terminology is used herein for purposes of reference only, and thus is not intended to be limiting. For example, terms such as “network device” refer to any system receiving and/or transmitting information packets in a computer network.

References to “a processor” can be understood to include one or more controllers or processors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to “memory,” unless otherwise specified, can include one or more processor-readable and accessible memory elements and/or components that can be internal to the processor-controlled device, external to the processor-controlled device, and can be accessed via a wired or wireless network. Furthermore, references to “network device,” can include one or more devices configured to send/receive data to/from network and can include, but is not limited to gateways, routers, network bridges, switches, hubs, repeaters, and NAS. It should be understood that a computer program may embrace constituent programs and that multiple programs may be implemented as a single or multiple programs.

Various features of the invention are set forth in the following claims. It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. A method for providing an interface to a first network device using a second device through one or more wired and/or wireless networks, comprising:
receiving an installation indication at a processor of the first network device from a remote application on a second network device;
determining whether a correlated application corresponding to the remote application is installed on the first network device;
transceiving data between the correlated application to the second network device based on a determination that the correlated application corresponding to the remote application is installed on the first network device; and
downloading the correlated application corresponding to the remote application based on a determination that the correlated application corresponding to the remote application is not installed on the first network device.

2. The method of claim 1, wherein downloading a router application includes transmitting a first network device specific message to the second network device including a first network device identifier or model.

3. The method of claim 1, wherein receiving an installation indication from the remote application includes receiving a message having a predefined protocol including the installation indication.

4. The method of claim 1, wherein the downloaded correlated application is selected from a plurality of correlated applications corresponding to the remote application based on one or more characteristics of the first network device.

S. The method of claim 1, further including executing the correlated application including instructions to modify a communication protocol for communication with a plurality of devices over the one or more wired or wireless networks.

6. The method of claim 5, wherein executing the correlated application to modify the communication with the plurality of devices includes configuring the first network device to act as an Internet of Things (IOT) huh for any IOT devices connecting to the first network device.

7. The method of claim 5, wherein executing the correlated application to modify the communication with the plurality of devices includes transmitting status information from the correlated application being executed to the second network device for display on the second network device.

8. The method of claim 5, wherein executing the correlated application to modify the communication with the plurality of devices includes updating firmware including instruction for performing the communication with the plurality of devices.

9. The method of claim 1, further including receiving a discovery query from a remote application on the second network device looking for devices supporting the remote application and responding to the queries with a positive feedback if the first network device can support the remote application.

10. A first network device generating a wired and/or wireless network and configured to facilitate communication with a plurality of client devices to the first network device, comprising:
a non-transient network device memory configured to store one or more network device applications; and
a network device processor configured to execute instructions to implement the one or more network device applications, the network device applications including at least a network device application manager configured to:
establish a communication link with a client device,
receive an installation indication from a remote application on the client device asking the network device to install a network device application that is a counterpart to the remote application,
download the counterpart application corresponding to the remote application based on the received installation instruction,
install the counterpart application on the first network device, and
perform functions based on the inputs from the remote application and return the results to the remote application to display to a user of the client device.

11. The first network device of claim 10, wherein downloading the counterpart application includes transmitting an installation message to the client device including a network device identifier.

12. The first network device of claim 10, wherein receiving an installation indication from the remote application includes receiving a message having a predefined protocol including the installation indication.

13. The first network device of claim 10, wherein the downloaded counterpart application is selected from a plurality of counterpart applications corresponding to the remote application based on one or more characteristics of the first network device.

14. The first network device of claim 10, further including executing the counterpart application including instructions to modify communication with a plurality of network devices.

15. The first network device of claim 14, wherein executing the counterpart application to modify the communication with the plurality of network devices includes configuring the first network device to act as an Internet of Things (IOT) hub for any JOT devices connecting to the first network device.

16. The first network device of claim 14, wherein executing the counterpart application to modify the communication with the plurality of network devices includes transmitting status information from the counterpart application being executed to the client device for display on the client device.

17. The first network device of claim 14, wherein executing the counterpart application to modify the communication with the plurality of network devices includes updating firmware including instructions for performing the communication with the plurality of network devices.

18, The first network device of claim 10, further including receiving a discovery query from a remote application on the client device looking for first network devices supporting the remote application and responding to the queries with a positive feedback if the first network device can support the remote application.

19. A portable computing device (PCD) for use in communicating with a network device generating a wired and/or wireless network to facilitate communication with a plurality of client devices, comprising:
a non-transient network device memory configured to store one or more device applications; and
a processor configured to execute instructions to implement the one or more device applications to:
identify the network device,
determine whether a network device application corresponding to the device application is installed on the network device,
transceive data with the network device application based on the execution of the network device application, and
display received output from the received network device application.

20. The portable computing device of claim 19, wherein the processor is further configured to act as an Internet of Things (IOT) hub based on a determination from data packets transmitted through the network device to or from a client device connected to the network device that the client device is an IOT device.
